(19) United States
(12) Patent Application Publication
(10) Pub. No.: US 2006/0010638 A1
(43) Pub. Date: Jan. 19, 2006

(54) Cleaner

(75) Inventors: Akio Shimizu, Hirakata-City (JP); Masato Nishikawa, Hirakata-City (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO Electric Co. Ltd., Moriguchi-shi (JP)

(21) Appl. No.: 11/179,605

(22) Filed: Jul. 13, 2005

(30) Foreign Application Priority Data
Jul. 14, 2004 (JP) 2004-207861 (P)

(51) Int. Cl. A47L 5/00; A47L 9/00; E01H 1/08

(52) U.S. Cl. 15/319; 15/340.4

(57) ABSTRACT

Only when a wall side and the vicinity of an obstacle are cleaned, a side brush is operated and the cleaning is carried out, and when any other place than the wall side and the vicinity of the obstacle is cleaned, the side brush is maintained in a stoppage state. When a place such as the wall side or the vicinity of the obstacle in which dust is easy to accumulate is cleaned, the side brush is operated to enhance the dust collecting property. When any other place than the wall side or the vicinity of the obstacle is cleaned, the side brush is stopped to suppress power consumption and generation of a noise. A judgment processing portion detects based on a detection signal from an obstacle detecting portion that a cleaner is approaching a wall or an obstacle. In response to such detection, the judgment processing portion instructs a travel steering portion to carry out immediate rotation and change of a travel direction, or travel along a wall side. Also, the judgment processing portion instructs a side brush driving portion to drive a side brush only in the rotation and in the wall side travel, and to stop the side brush in straight advance travel.

This application claims priority under 35 U.S.C. §119 of Japanese Patent Application No. 2004-207861 filed Jul. 14, 2004.

### BACKGROUND OF THE INVENTION

1. Field of the Invention

The present invention relates to a cleaner, and more particularly to a self-propelled vacuum cleaner including auxiliary dust collecting means such as a side brush in addition to dust collecting means such as a dust collecting port or a suction nozzle.

2. Description of the Related Art

In recent years, a so-called self-guided, self-propelled vacuum cleaner having a microcomputer and various sensors mounted therein has been developed and come into wide use.

Normally, dust collecting means such as a suction nozzle or a brush is provided in a bottom portion of a main body of a self-propelled vacuum cleaner of this sort. During a self-guided, self-propelled operation, occasional travel positions are measured based on rotational frequencies of wheels and a travel direction. In addition, an obstacle located forward in the travel direction is detected by contact type or non-contact type sensing means, and the travel direction is changed accordingly to avoid the obstacle. Note that in addition to the method utilizing the self-contained navigation (technique for measuring a travel position based on rotational frequencies of wheels and a travel direction) as described above, the technique based on the inertial navigation using a gyroscope can be used for the measurement of the travel position.

As regards such a self-propelled vacuum cleaner, a cleaner has been developed in which auxiliary dust collecting means such as a rotating brush is provided in addition to dust collecting means such as a suction nozzle or a brush. With this cleaner, during the cleaning, the auxiliary dust collecting means such as the rotating brush is operated, thereby enhancing the dust collecting property in a travel path.

JP 7-322977 A discloses a technique for reducing a rotational frequency of a side brush when the brush is cleaning along the wall or when a self-propelled movement direction is reversed. According to this technique, it is possible to prevent a side brush from scratching a wall, a carpet, or the like when the brush is cleaning along the wall or when the self-propelled movement direction is reversed.

However, in such a conventional self-propelled vacuum cleaner, there arises a problem that an electric power is consumed and a large noise is generated all the more because the side brush is usually rotating during the cleaning. In addition, the side brush is effective to collect the dust, for example, near the wall or around obstacles which is hardly collected by the main collecting means. However, there is a possibility that when the self-propelled vacuum cleaner travels in a place which does not have many obstacles such as a center of a room, the side brush scatters the dust about rather than collects the dust. Moreover, the possibility that the side brush catches a feeder cord or the like becomes higher.

### SUMMARY OF THE INVENTION

It is an object of the present invention to provide a self-propelled vacuum cleaner which is capable of effectively suppressing power consumption and noise generation while maintaining a high dust collecting property, and of preventing a side brush from scattering dust, tangling a cord, or the like as much as possible.

A main feature of the present invention is that a side brush is operated only when necessary such as when the cleaner is cleaning along the wall or around obstacles. Thus, the dust collecting property is enhanced in a place in which the dust is hardly collected or in a place in which the dust is easy to accumulate. The excessive power consumption, the generation of the noise, the scattering of the dust, the tangling of the cord, and the like by the side brush are suppressed in any place other than those places.

An aspect of the present invention is characterized by a cleaner, including: dust collecting means; a side brush; obstacle detecting means for detecting an obstacle; and brush control means for controlling drive of the side brush based on detection results obtained by the obstacle detecting means. Here, when an obstacle is detected by the obstacle detecting means, the brush control means starts to drive the side brush, and when the obstacle detecting means does not detect an obstacle, the brush control means stops driving the side brush.

In addition, it is possible to adopt a configuration that the detection results obtained by the obstacle detecting means reveal that a distance to an obstacle is equal to or smaller than a first predetermined value, the brush control means judges that an obstacle is present and drives the side brush, and when the detection results obtained by the obstacle detecting means reveal that the distance to the obstacle is beyond the first predetermined value, the brush control means judges that no obstacle is present and stops driving the side brush.

Further, when the cleaner according to the present invention further includes self-propelled movement means, it is possible to adopt a configuration that when the detection results obtained by the obstacle detecting means reveal that the distance to the obstacle is equal to or smaller than a second predetermined value, the self-propelled movement means changes a travel direction of the cleaner while the brush control means drives the side brush.

It is also possible to adopt a configuration that after the self-propelled movement means changes the travel direction of the cleaner, the brush control means stops driving the side brush. More specifically, when the detection results obtained by the obstacle detecting means reveal that the distance to the obstacle becomes equal to or larger than a third predetermined value after the self-propelled movement means changes the travel direction of the cleaner, the brush control means stops driving the side brush.

Moreover, when the cleaner according to the preset invention further includes self-propelled movement means, it is possible that the brush control means drives the side brush and the self-propelled movement means maintains the distance to the obstacle based on the detection results obtained by the obstacle detecting means.

According to the present invention, only when places such as near the wall and around obstacles are cleaned where the dust is easy to accumulate, the side brush is operated and the cleaning using the side brush is carried out. Thus, the dust collecting property in those places can be enhanced. In addition, when a place other than those places is cleaned, since the operation of the side brush is stopped, the excessive power consumption and the noise generation by the side brush are suppressed. Also, the scattering of the dust and the tangling of the cord by the side brush are prevented.

Consequently, according to the present invention, it is possible to provide the cleaner which is capable of suppressing the scattering of the dust and the tangling of the cord while suppressing the excessive power consumption and the generation of the noise, and of effectively cleaning places such as near the wall and around obstacles where the dust is easy to accumulate.

### BRIEF DESCRITION OF THE DRAWINGS

The above and other objects and novel features of the present invention will be more perfectly clear when the following description of preferred embodiments is read with reference to the accompanying drawings, in which:

FIG. 1 is a perspective view of a main portion of a cleaner according to an embodiment of the present invention;

FIG. 2 is a bottom view of the cleaner according to the embodiment of the present invention;

FIG. 3 shows a functional block of the cleaner according to the embodiment of the present invention;

FIGS. 4A, 4B, and 4C are diagrams explaining a construction of a rotational frequency detecting portion of the cleaner according to the embodiment of the present invention;

FIG. 5 shows an example of an operation for cleaning a rectangle-shaped room by the cleaner according to the embodiment of the present invention;

FIG. 6 is a flow chart in an along-wall travel mode of the cleaner according to the embodiment of the present invention;

FIGS. 7A, 7B, 7C, and 7D illustrate a wall detecting operation in the along-wall travel mode of the cleaner according to the embodiment of the present invention;

FIGS. 8A, 8B, 8C, and 8D illustrate how to turn a corner of a wall in the along-wall travel mode of the cleaner according to the embodiment of the present invention;

FIGS. 9A, 9B, 9C, and 9D illustrate how to turn a corner of a wall in the along-wall travel mode of the cleaner according to the embodiment of the present invention;

FIG. 10 is a flow chart of a random travel mode of the cleaner according to the embodiment of the present invention;

FIGS. 11A, 11B, 11C, and 11D illustrate a method of calculating a rotation angle in the random travel mode of the cleaner according to the embodiment of the present invention;

FIGS. 12A and 12B illustrate a method of calculating a rotation angle in the random travel mode of the cleaner according to the embodiment of the present invention;

FIG. 13 is another flow chart in the random travel mode of the cleaner according to the embodiment of the present invention;

FIG. 14 shows an example of a cleaning operation in a rectangle-shaped room of the cleaner according to the embodiment of the present invention; and

FIGS. 15A, 15B, 15C, and 15D illustrate a cleaning operation carried out along an obstacle or the like in the random travel mode of the cleaner according to the embodiment of the present invention.

### DETAILED DESCRIPTION OF THE PREFERRED EMBODIMENTS

Hereinafter, an embodiment of the present invention will be described with reference to the accompanying drawings.

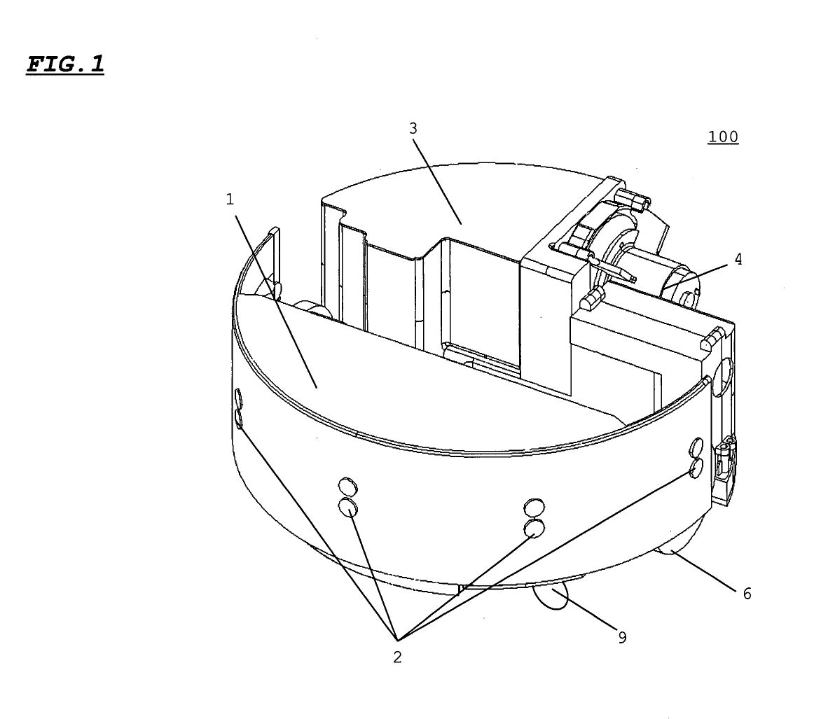

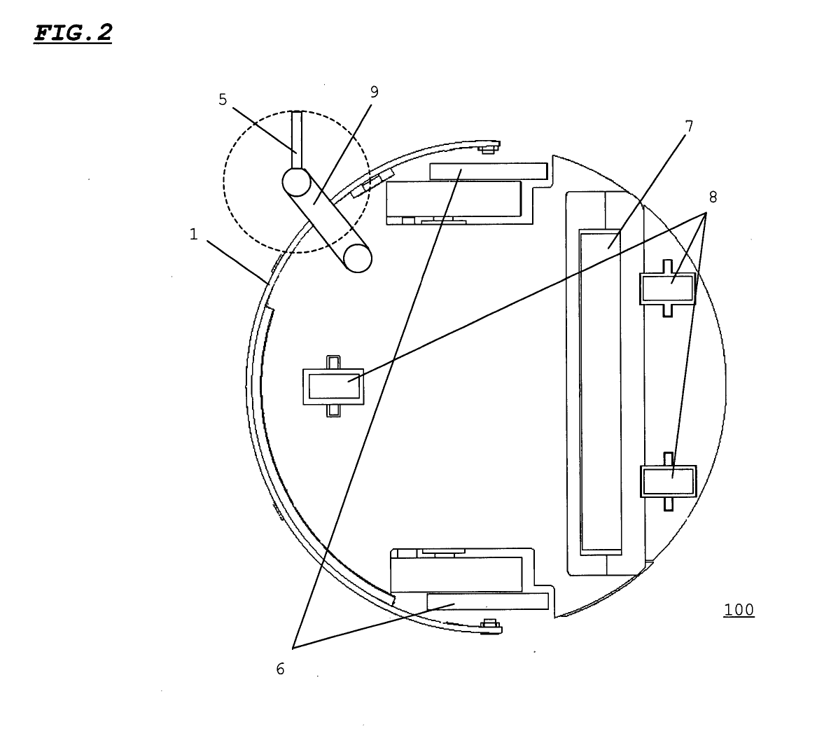

FIG. 1 is a perspective view of a cleaner 100 according to an embodiment of the present invention, and FIG. 2 is a bottom view of the cleaner 100 according to the embodiment of the present invention.

Referring to FIG. 1, reference numeral 1 designates a bumper; 2, an obstacle detecting sensor; 3, a dust collecting box; and 4, a fan motor for a dust collecting operation.

The bumper 1 doubles as a contact type sensor such as a switch for detecting, when an obstacle or the like unexpectedly contacts the cleaner 100, the unexpected contact. The bumper 1 functions as a sensor for carrying out a stoppage, a back operation, or the like of the cleaner 100 when, for example, a leg or the like of someone suddenly touches the cleaner 100.

The obstacle detecting sensor 2 is a non-contact type sensor such as an ultrasonic sensor for detecting an obstacle. Several sets of obstacle detecting sensors 2 are mounted to a side face of a main body of the cleaner 100 with a transmission portion and a reception portion as one set. The obstacle detecting operation is carried out such that an obstacle detection signal is generated from the transmission portion, and the obstacle detection signal reflected by the obstacle is received by the reception portion.

Referring to FIG. 2, reference numeral 5 designates a side brush, and reference numeral 6 designates a driving wheel. The two driving wheels 6 are disposed in a left-hand side and a right-hand side of the cleaner 100, respectively. Also, reference numeral 7 designates a dust collecting port; 8, an auxiliary wheel; and 9, an arm for supporting the side brush 5.

The dust collecting port 7 is a suction port for sucking dust or the like. The side brush 5 is mounted to a tip of the arm 9 projecting from the bottom surface of the main body of the cleaner 100. The side brush 5 is mounted so that a head of the side brush 5 projects at least from a peripheral surface of the main body of the cleaner 100. As regards the side brush 5, there are known several side brushes such as a cup type brush and a rod type brush. In this embodiment, the rod type brush is used as the side brush 5. The rod type brush is adapted to rotate at the head of the arm 9 with its one end as a center.

Note that the cleaner 100 may be provided with such a mechanism that a stopper etc. stop an operation of the rod type brush in an arm lower portion. As a result, when the cleaner 100 travels with the side brush 5 being unused, an unnecessary part such as a cord is prevented from being tangled round the side brush 5. It is supposed that in this embodiment, the cleaner 100 has such a mechanism (not shown in FIG. 2) installed therein.

The travel direction of the cleaner 100 is changed to a left-hand or right-hand side depending on the difference in rotational frequency between the left-hand driving wheel and the right-hand driving wheel. Note that the change of the travel direction may also be carried out by steering the cleaner using the direction guidance wheel in addition thereto.

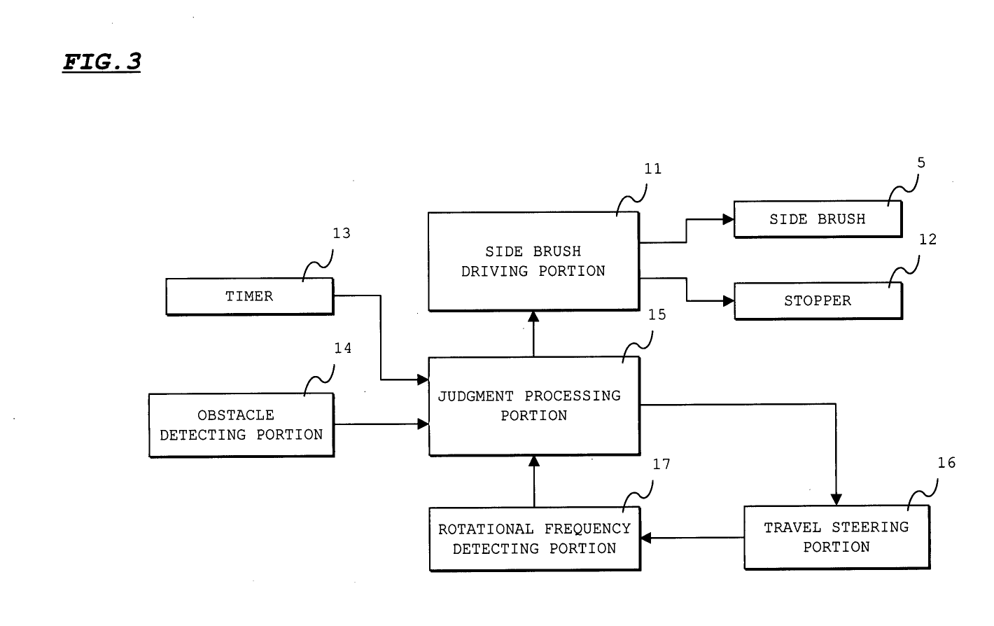

FIG. 3 is a functional block diagram of the cleaner 100 according to this embodiment. In FIG. 3, reference numeral 11 designates a side brush driving portion for driving the side brush 5; 12, the stopper described above; 13, a time measuring timer; 14, an obstacle detecting portion including an obstacle detecting sensor; 15, a judgment processing portion for carrying out the processing, the judgment, and the control for the individual portions; 16, a travel steering portion including a motor and the like; and 17 designates a rotational frequency detecting portion for detecting an operation of the travel steering portion 16.

Operations of the respective portions in this embodiment will hereinafter be described with reference to FIG. 3.

The obstacle detecting portion 14 outputs a detection signal to the judgment processing portion 15 in response when the reception portion of any one of the obstacle detecting sensors 2 receives the obstacle detection signal. Still when the obstacle detection signal reflected by the obstacle is received and is then amplified by an amplifying circuit, and the level of the resultant signal exceeds a certain threshold, the obstacle detecting portion 14 outputs the detection signal. Thus, the sensitivity for the obstacle detection can be changed through the tuning of a circuit constant of the amplifying circuit, or the change of the threshold.

The judgment processing portion 15 carries out the detection of the presence or absence of an obstacle, and the calculation for a distance to the obstacle based on the detection signal or the like inputted thereto. More specifically, the judgment processing portion 15 carries out the detection of the presence or absence of an obstacle based on the reception of the detection signal from a certain reception portion, and carries out the calculation for the distance to the obstacle based on a time difference between the obstacle detection signal output timing and the detection signal checking timing.

The judgment processing portion 15 inputs an instruction to request to drive or stop the side brush 5 to the side brush driving portion 11 in correspondence to the results of the detection of the obstacle or the calculation for the distance to the obstacle. The side brush driving portion 11 carries out the control for the side brush 5 in accordance with the individual instruction inputs. Note that when stopping the side brush 5, the side brush driving portion 11 simultaneously operates the stopper 12.

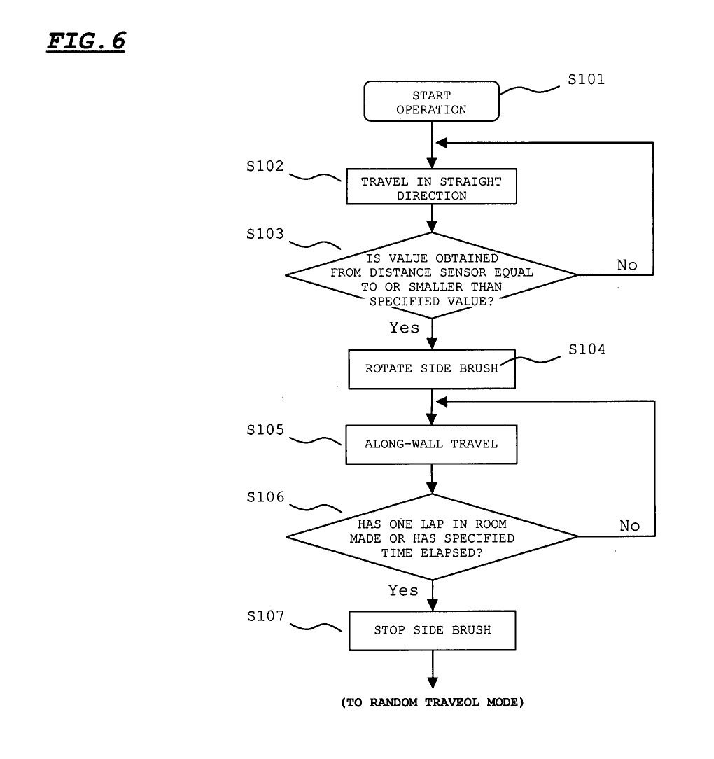

An output from the time measuring timer 13 is used for the purpose of measuring a certain time, preventing an infinite operation, and so forth by the judgment processing portion 15. Note that a specific usage method will be described in detail later with reference to processing flow charts shown in FIG. 6 and the like.

The judgment processing portion 15 inputs an instruction for a forward movement, a backward movement, or a stop operation to the travel steering portion 16. The travel steering portion 16 carries out the moving operation in accordance with the instruction input, and controls the motor for the left-hand and right-hand side driving wheels to change the travel direction of the cleaner 100 to the left-hand direction or the right-hand direction.

The rotational frequency detecting portion 17 successively detects the rotating operations of both the left-hand and right-hand driving wheels in the travel steering portion 16 to output the detection results to the judgment processing portion 15. The judgment processing portion 15 detects the rotational frequencies of the left-hand and right-hand driving wheels based on the detection results, calculates the moving speed of the cleaner 100 based on the detected rotational frequencies of the left-hand and right-hand driving wheels, and calculates an angle by which the travel direction of the cleaner 100 is changed based on the rotational frequency difference between the rotational frequencies of the left-hand and right-hand driving wheels.

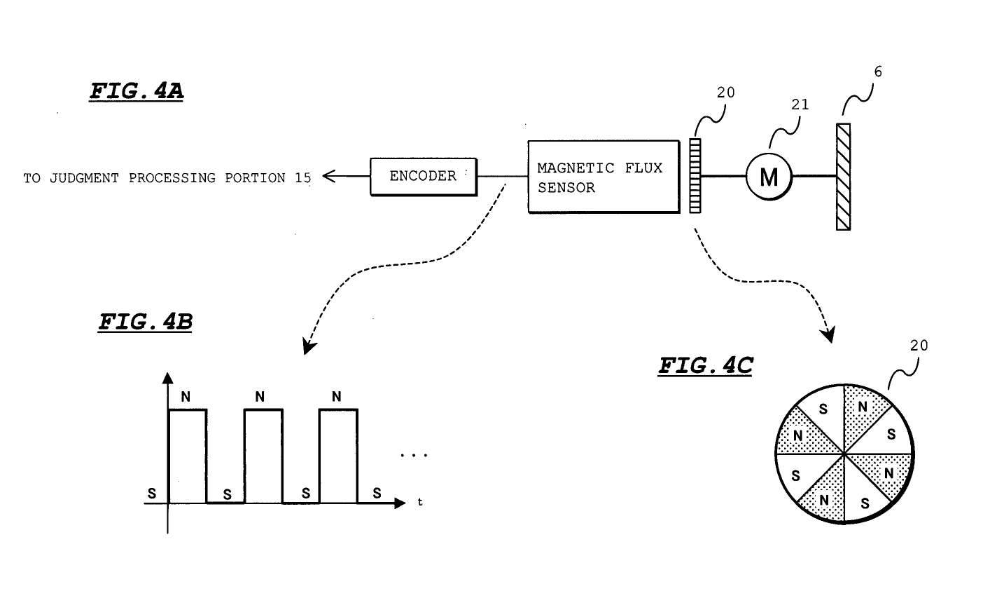

Referring now to FIG. 4A, a rotational frequency of the driving wheels is calculated by using a magnet 20 and a magnetic flux sensor to detect the rotational frequency of a motor 21 and compute its rotational frequency in a rotational frequency encoder. FIG. 4B shows a waveform of an output from the magnetic flux sensor which is plotted along a time axis. The output from the magnetic flux sensor is changed between an H level and an L level in correspondence to the changing of the polarity of the magnet 20 between an N pole and an S pole. FIG. 4C shows a structure of the magnet 20 within a plane intersecting perpendicularly a rotating axis of the magnet 20. The N pole and the S pole are alternately set in the magnet 20.

The judgment processing portion 15 measures a cleaner's own position of the cleaner 100 based on the data (the rotational frequencies of the left-hand and right-hand driving wheels and the rotational frequency difference therebetween) obtained in the manner as described above (self-contained navigation). Note that the judgment processing portion 15 may also detect a cleaner's own position by utilizing the inertial navigation using a gyroscope, an acceleration sensor, and the like.

In the cleaner 100 according to this embodiment, after a power supply is turned ON, a cleaning operation based on an along-wall travel mode is carried out. After the cleaning operation based on the along-wall travel mode is completed, a cleaning operation based on a random travel mode is carried out.

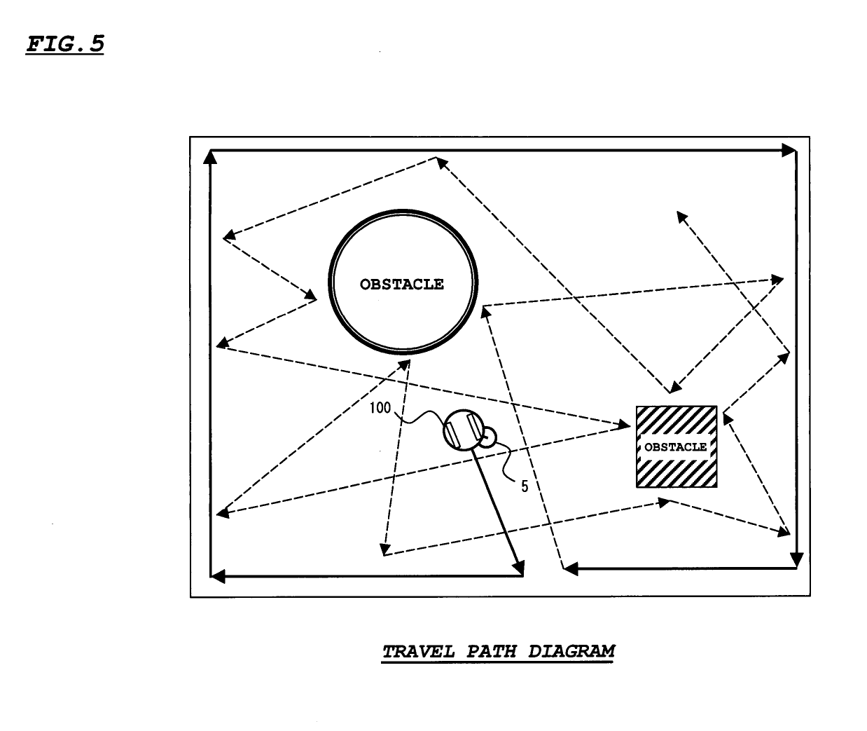

FIG. 5 shows an example of the cleaning operation when two obstacles exist in a rectangle-shaped room. In FIG. 5, a solid line portion indicates a cleaning operation path based on the along-wall travel mode, and a broken line portion indicates a cleaning operation path based on the random travel mode.

Hereinafter, the cleaning operations in those two travel modes will be described in detail. Note that the operation such as the backward movement or the stop operation by the bumper switch is interruptedly carried out in each of the following travel modes, and an interruption operation is carried out for a predetermined time.

[Along-Wall Travel Mode]

FIG. 6 is a flow chart explaining the operation of the cleaner 100 according to this embodiment. Note that the cleaner 100 is placed in the vicinity of the wall so that its travel direction is directed toward the wall as a pre-preparation of the cleaner 100.

In Step S101, the power supply is turned ON to start the cleaning operation.

In Step S102, the cleaner 100 carries out the self-propelled travel for a forward movement based on the self-guidance while carrying out the cleaning operation for collecting the dust. At this time, the side brush is held in a stop state. Note that during the self-propelled travel, the judgment processing portion 15 carries out the measurement of the cleaner's own position and grasps a shape of a room and positions of obstacles within the room (hereinafter referred to as “mapping”) based on output information from the rotational frequency detecting portion 17. In the following operation, during the movement of the cleaner 100, the mapping is carried out unless otherwise specified.

In Step S103, the wall is detected. That is, as previously stated, a distance to the wall is detected based on the time difference between the output timing of the obstacle detection signal and the reception timing of the detection signal. When the distance to the wall is equal to or smaller than a specified value, the cleaner 100 judges that the cleaner 100 reaches a position very close to the wall, the operation proceeds to Step S104. On the other hand, when the distance to the wall is larger than the specified value, the operation returns back to Step S102.

In Step S104, the rotating operation of the side brush 5 is started. In and after Step S104, the cleaning operation based on the along-wall travel is carried out while the side brush 5 is used.

In Step 105, the cleaner 100 travels forward while cleaning the room along the wall in a state in which the judgment processing portion 15 maintains a constant distance to the wall using the results of the output of a distance sensor. Note that when the cleaner 100 reaches a corner of the wall, the cleaner 100 changes its travel direction, and thereafter continues to carry out the along-wall cleaning similarly to the previous operation. Further, a distance to the wall is assumed to be a value determined by considering the distance to the wall, up to which the cleaner can clean the room using the side brush 5.

In Step S106, it is judged based on the mapping results and the measurement results of the cleaner's own position whether or not the cleaner 100 has made one lap in the room or the specified time has elapsed. Here, when it is judged in Step S106 that the cleaner 100 has made one lap in the room, or when it is judged in Step S106 based on a value in the time measuring timer 13 that the specified time has elapsed, the operation proceeds to Step S107. On the other hand, when it is judged in Step S106 that the cleaner 100 has not made one lap in the room, or when it is judged in Step S106 that no specified time has elapsed, the operation returns back to Step S105 and the along-wall cleaning is continued.

In Step S107, it is judged that the cleaning operation based on the along-wall travel is completed, and the rotation of the side brush 5 is stopped.

The along-wall travel mode is completed through the above-mentioned operation, and the operation proceeds to the next random travel mode.

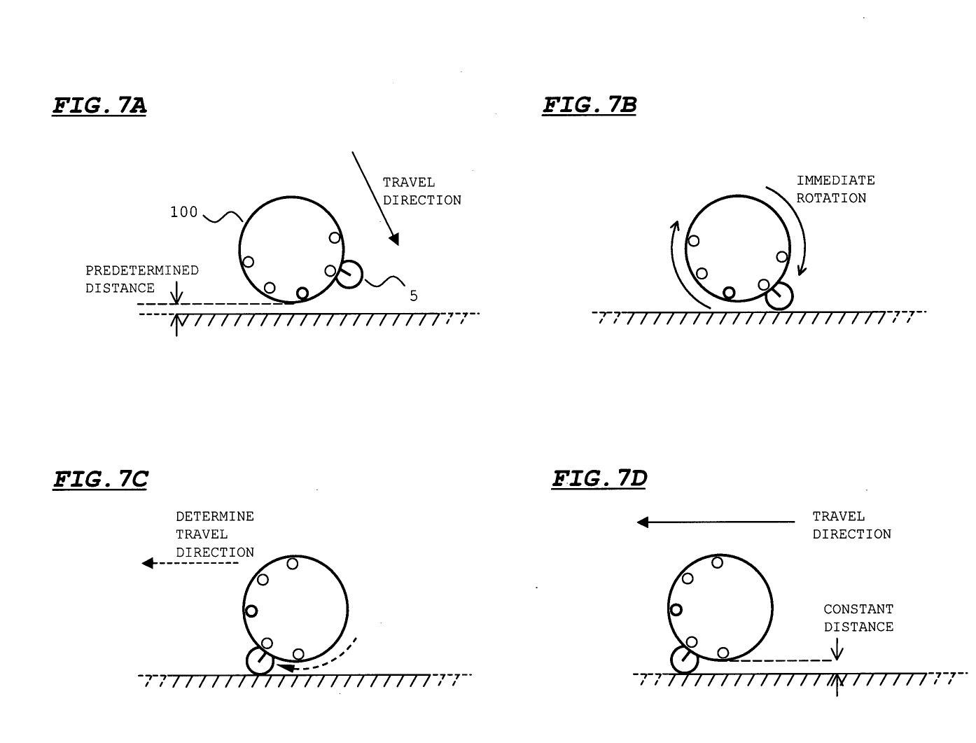

Note that, the along-wall travel in Step S105 will hereinafter be described with reference to FIGS. 7A to 7D.

Firstly, the operation at the beginning of the along-wall travel will be described with reference to FIGS. 7A to 7D.

When any one of the sensors 2 in FIG. 7A detects a wall during the straightly advancing operation, the cleaner 100 stops at a predetermined distance from the wall accordingly. Next, in FIG. 7B, a rotation angle of the cleaner 100 is determined in correspondence to which sensor detects the wall, and the cleaner 100 rotates immediately by the rotation angle thus determined. As a result, the travel direction of the cleaner 100 is changed. After such rotation is completed, in FIG. 7C, the travel direction of the cleaner 100 is determined as a direction parallel with the wall. Then, in FIG. 7D, the forward movement operation is started in which the distance to the wall is kept constant while the detection results obtained by the sensor are used.

Note that each of the predetermined distance and the constant distance shown in FIGS. 7A and 7D, respectively, is a distance to which the cleaner 100 can approach the wall for cleaning by using the side brush 5 without colliding with the wall (this is also applied to the following description).

In such a manner, the cleaner 100 cleans the room using the side brush 5 while traveling along the wall.

Note that as can be seen by referring to FIGS. 1 and 2, since the side brush 5 is installed in a left-side lower portion of the main body of the cleaner 100, when in this embodiment, the operation for cleaning the room along the obstacle, the wall, or the like is carried out using the side brush 5, the control or the like for the rotation of the cleaner 100 is carried out so that the wall, the obstacle, or the like is located on the left-hand side with respect to the travel direction.

Next, an explanation will be made with respect to an operation when the cleaner 100 reaches a corner of the wall.

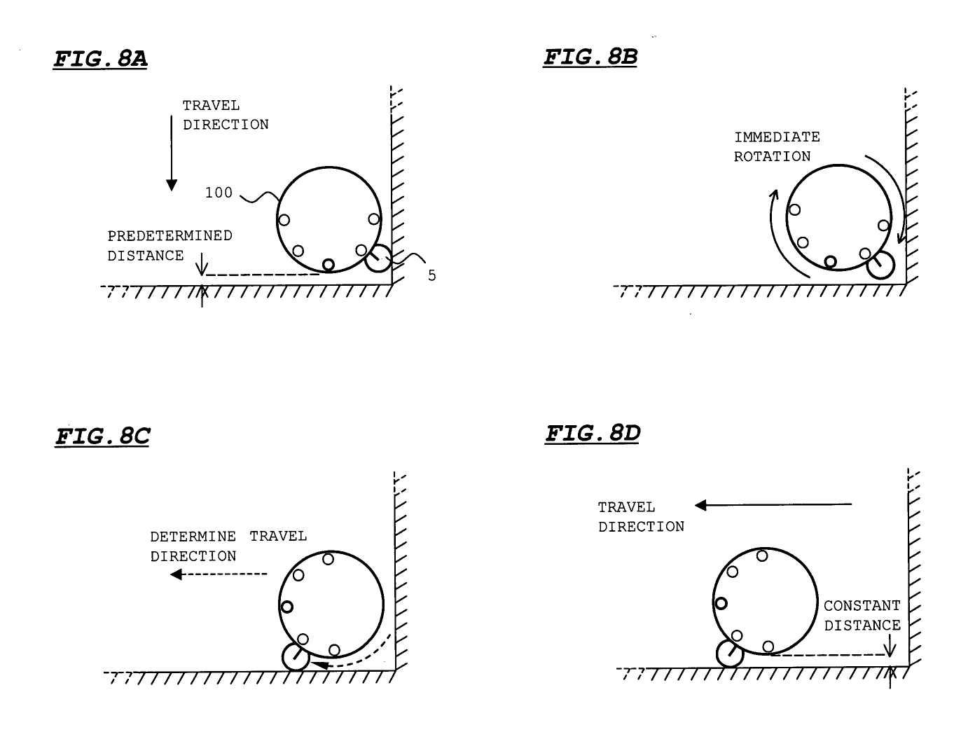

Firstly, an explanation will be made with respect to an operation when the cleaner 100 reaches a corner of a wall, and when the wall exists forward in the travel direction with reference to FIGS. 8A to 8D. When in FIG. 8A, any one of the sensors 2 detects the wall existing in front of the cleaner 100, the cleaner 100 stops at a predetermined distance from the wall accordingly. Next, in FIG. 8B, a rotation angle of the cleaner 100 is determined in correspondence to which sensor detects the wall, and the cleaner 100 rotates immediately by the rotation angle thus determined. As a result, the travel direction of the cleaner 100 is changed. After such rotation is completed, in FIG. 8C, the travel direction of the cleaner 100 is determined as a direction parallel with the wall which exists in front of the cleaner 100 when the cleaner 100 approaches the corner of the wall. Then, in FIG. 8D, the forward movement of the cleaner 100 is restarted in which the distance to the wall is held constant using the detection results obtained by the sensor 2.

Note that in FIG. 8B, the cleaner 100 may also be equipped with a mechanism in which an arm is adapted to expand and contract so that the side brush 5 reaches even the inner part of the corner of the wall in order to rake the dust from the corner of the wall. In this case, for example, control is carried out such that the arm expands to the full in the middle of the rotation operation.

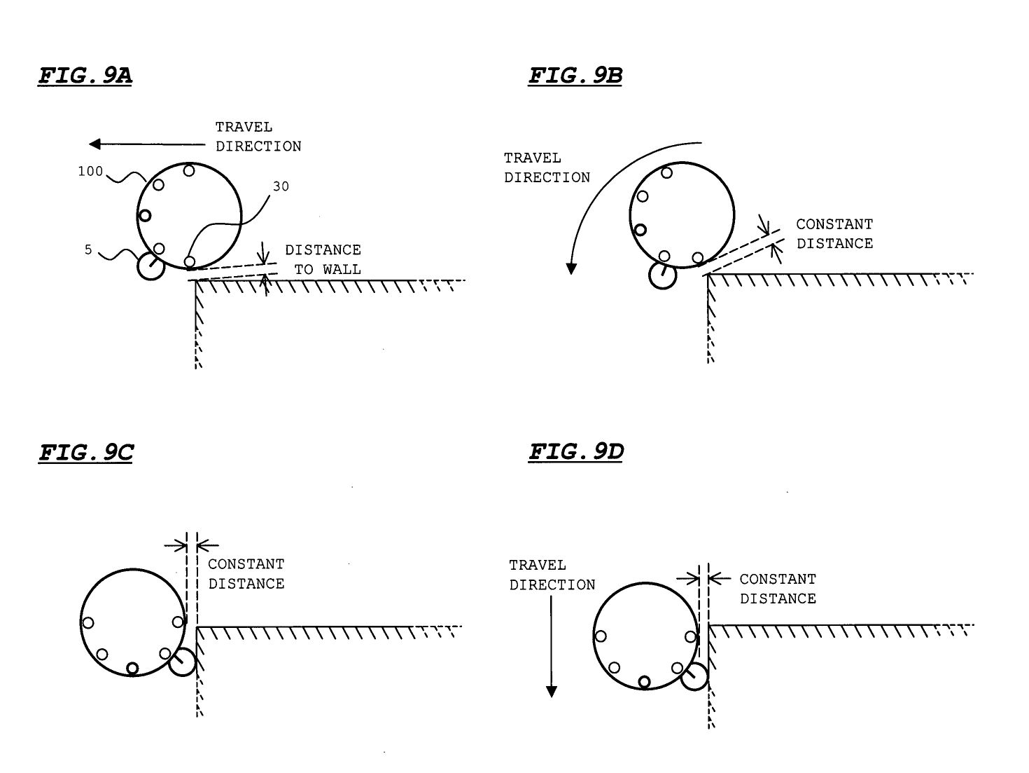

Next, a description will be given with respect to the operation when the cleaner 100 reaches the corner of the wall as shown in FIG. 9A. In this case, the cleaner 100 turns to the left in accordance with the control for holding a constant distance between an obstacle and the rear left portion of the cleaner 100.

Referring to FIG. 9A, when a sensor 30 detects that the distance from the wall begins to become longer, in FIG. 9B, the cleaner 100 turns to the left based on the distance to the obstacle detected by the sensor 30 so that the distance between the cleaner 100 and the wall is held constant, thereby changing the travel direction of the cleaner 100. After that, after in FIG. 9C, the change of the travel direction of the cleaner 100 is completed, in FIG. 9D, the forward movement of the cleaner 100 is restarted in which the distance to the wall is held constant using the detection results obtained by the sensor 30.

In such a manner, the cleaner 100 carries out the cleaning operation using the side brush 5 while traveling along the wall.

[Random Travel Mode]

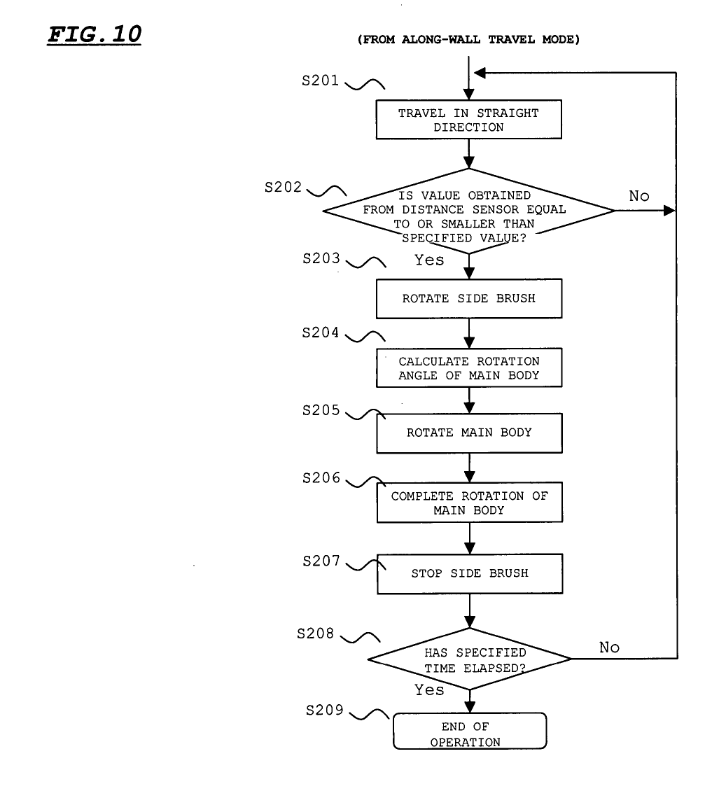

Next, the operation of the cleaner 100 during the random travel will be described with reference to a flow chart of FIG. 10.

The operation proceeds from Step S107 in the above-mentioned along-wall travel mode to Step S201 shown in FIG. 10, thereby starting the random travel mode. Upon this shift, the travel direction of the cleaner 100 is changed so that the cleaner gets away from the wall as a pre-preparation. For example, the travel direction of the cleaner 100 is turned by 90°.

In Step S201, the cleaner 100 carries out the self-propelled travel for a forward movement based on the self-guidance while carrying out the dust cleaning operation. At this time, the side brush 5 is in a stoppage state in Step S107. Note that though during such self-propelled travel, the cleaner 100 may travel using the results of the cleaner's own position check and the mapping work while the cleaner's own position check and the mapping work are carried out, in this embodiment, no mapping is carried out in the random travel mode.

In Step S202, a wall, an obstacle, or the like is detected. When a distance to the obstacle or the like is equal to or smaller than a specified value, it is judged that the cleaner 100 will collide with the obstacle or the like, and the operation proceeds to Step S203. On the other hand, when the distance to the obstacle or the like is larger than the specified value, the operation returns back to Step S201.

In Step S203, the operation for rotating the side brush 5 is started. In the operation in and after Step S203, the work for cleaning the room along the wall, around the obstacle, or the like is carried out while the side brush 5 is used.

In Step S204, a rotation angle of the cleaner 100 is calculated to avoid the collision of the cleaner 100 with the obstacle or the like.

In Step S205, the forward movement of the cleaner 100 is stopped, and the cleaner 100 is rotated by the rotation angle calculated in Step S204. As a result, the travel direction of the cleaner 100 is changed. Note that during such rotation, the cleaning operation and the rotation of the side brush are continued.

In Step S206, the rotation of the cleaner 100 is completed at timing when the cleaner 100 is rotated by the above-mentioned rotation angle. After that, the forward movement of the cleaner 100 is started.

In Step S207, the rotation of the side brush 5 is completed in correspondence to the completion of the operation for rotating the cleaner 100. However, the cleaning operation is continuously carried out. Note that the control for operating the side brush 5 may also be carried out until the distance to the obstacle or the like becomes equal to or larger than the specified value. Alternatively, the control for stopping the side brush 5 after a lapse of a predetermined time may also be carried out after completion of the operation for rotating the cleaner 100.

In Step S208, it is judged based on the value in the time measuring timer 13 whether or not a specified time has elapsed. When it is judged that the specified time has elapsed, the operation proceeds to Step S209. On the other hand, when it is judged that no specified time has elapsed, the operation returns to Step S201, and the random travel mode is continued.

Since in Step S209, the cleaning operations based on the two travel modes have been completed, all the operations are completed.

Note that it is ideal that the collision of the cleaner 100 with an obstacle or the like can be avoided with the rotation angle calculated in Step S204. However, when the obstacle has a complicated shape, and so forth, a case may occur where the collision of the cleaner 100 with the obstacle cannot be avoided at the rotation angle. However, in this case as well, since a flow proceeds as follows: Step S208→Step S201→Step S202→Step S203, and the next rotation angle is instantaneously calculated, the avoidance of the collision of the cleaner 100 with the obstacle is compensated for.

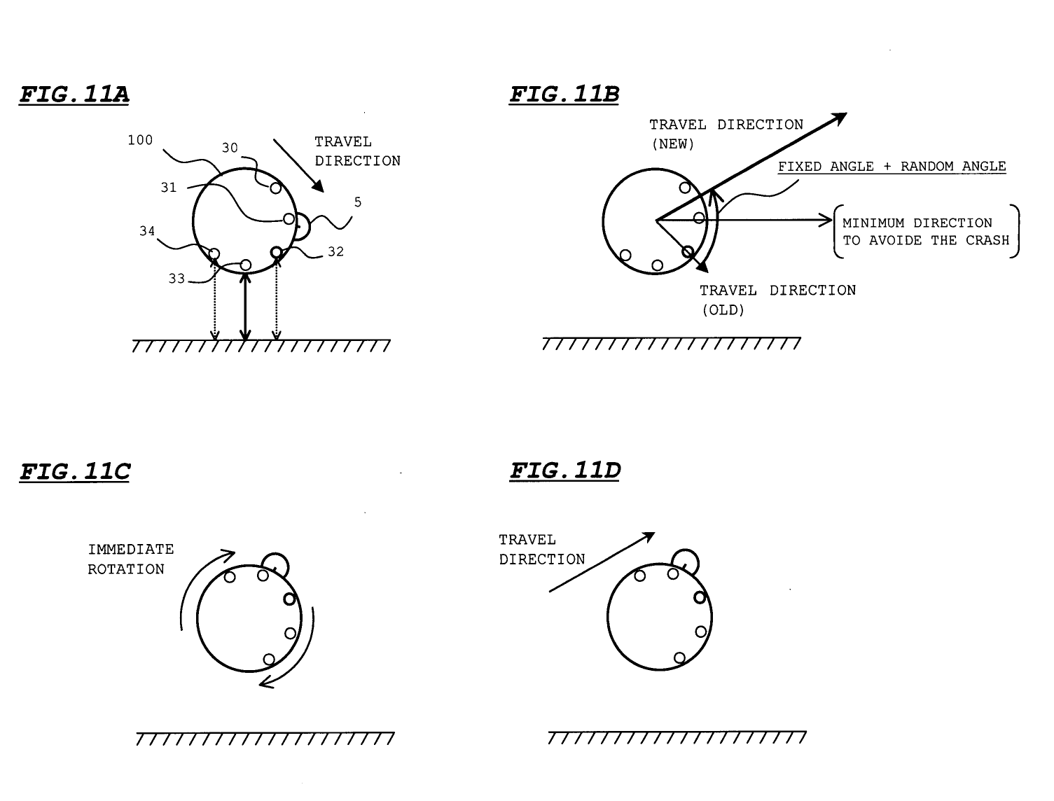

Next, a description will be given with respect to a method of calculating a rotation angle of the cleaner 100 ensuring the avoidance of the collision of the cleaner 100 with an obstacle or the like with reference to FIGS. 11A to 11D. Note that in FIGS. 11A to 11D, reference numerals 30 to 34 designate pairs of sensors (each including the transmission portion and the reception portion) of the obstacle detecting sensors 2 shown in FIG. 2.

When an obstacle is detected in FIG. 11A, a rotation angle of the cleaner 100 is calculated in FIG. 11B, and the cleaner 100 is immediately rotated by the rotation angle thus calculated with the travel of the cleaner 100 being stopped in FIG. 11C. As a result, the travel direction of the cleaner 100 is changed. After that, in FIG. 11D, the cleaner 100 moves forward in a new travel direction. Thus, in the case shown in FIGS. 11A to 11D, since the travel direction of the cleaner 100 is changed to the left-hand side with respect to the former travel direction, the collision of the cleaner 100 with the obstacle is avoided.

In FIG. 11A, the sensor pair 33 nearest the obstacle detects the obstacle. In FIG. 11B, the direction which is obtained by adding a random angle based on random numbers to a fixed angle inherent in the sensor pair 33 is set as the new travel direction. Here, the reason for using the random angle is that a possibility, that a situation may arise in which the travel path of the cleaner 100 keeps to a certain travel path and thus the cleaner 100 cleans only the same place, is excluded by adding the random angle when the new travel direction is calculated. In FIG. 11C, the cleaner 100 is rotated in a clockwise direction by an angle of “360° −(fixed angle+random angle)” in order to carry out the work for cleaning a place just near the obstacle using the side brush 5.

The fixed angle is set every sensor pair in consideration of the positions where the sensor pairs are disposed in the cleaner 100. That is, even when the random angle is a value near zero, the fixed angle is set as such an angle that the travel direction of the cleaner 100 becomes a direction away from the wall as compared with the minimum avoidance direction shown in FIG. 11B.

Note that since the sensor pairs are mounted at intervals, an event in which the sensor pair 33 detects the obstacle may occur in a case where a distance between the sensor pair 33 and the obstacle is slightly shorter than that between the next sensor pair 32 on the right side of the sensor pair 33 and the obstacle as well as in a case where the distance between the sensor pair 33 and the obstacle is slightly shorter than that between the next sensor pair 34 on the left side of the sensor pair 33 and the obstacle.

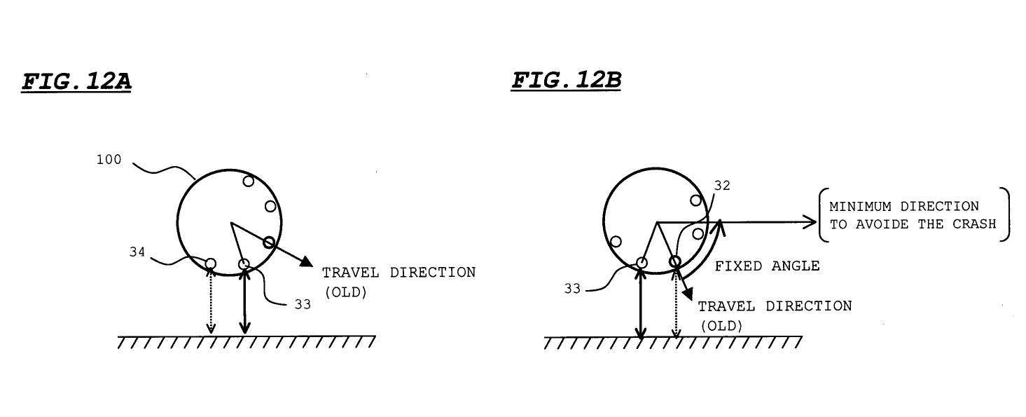

FIG. 12A shows the case where the distance between the sensor pair 33 and the obstacle is slightly shorter than that between the sensor pair 34 and the obstacle, and FIG. 12B shows the case where the distance between the sensor pair 33 and the obstacle is slightly shorter than that between the sensor pair 32 and the obstacle.

The above-mentioned fixed angle must be determined in consideration of the travel angle of the cleaner 100 with respect to the obstacle in such a manner. More specifically, a fixed angle shown in FIG. 12B is adopted as the fixed angle inherent in the sensor pair 33. When the fixed angle inherent in the sensor pair 33 is set to this value, even if the random angle takes a value near zero, the possibility that the cleaner 100 collides with the obstacle is excluded. With this fixed angle, the collision of the cleaner 100 with the obstacle can be avoided even in the case shown in FIG. 12A.

This is also applied to the setting of the fixed angle for other sensor pairs. In addition, the foregoing can also be applied to the case where a course of the cleaner 100 is changed to the right-hand side with respect to the former travel direction in order to avoid the collision of the cleaner 100 with the obstacle. In such a manner, the fixed angles inherent in the respective sensor pairs are determined.

Next, there is shown another operation form in the random travel mode. In this operation form, when it is judged that the cleaner 100 will collide with the obstacle or the like, in order to avoid the collision of the cleaner 100 with the obstacle or the like, the direction of the cleaner 100 is not changed, but the cleaning is carried out in which the side brush 5 is driven for a predetermined time or over a given distance while the cleaner 100 travels along the obstacle or the like.

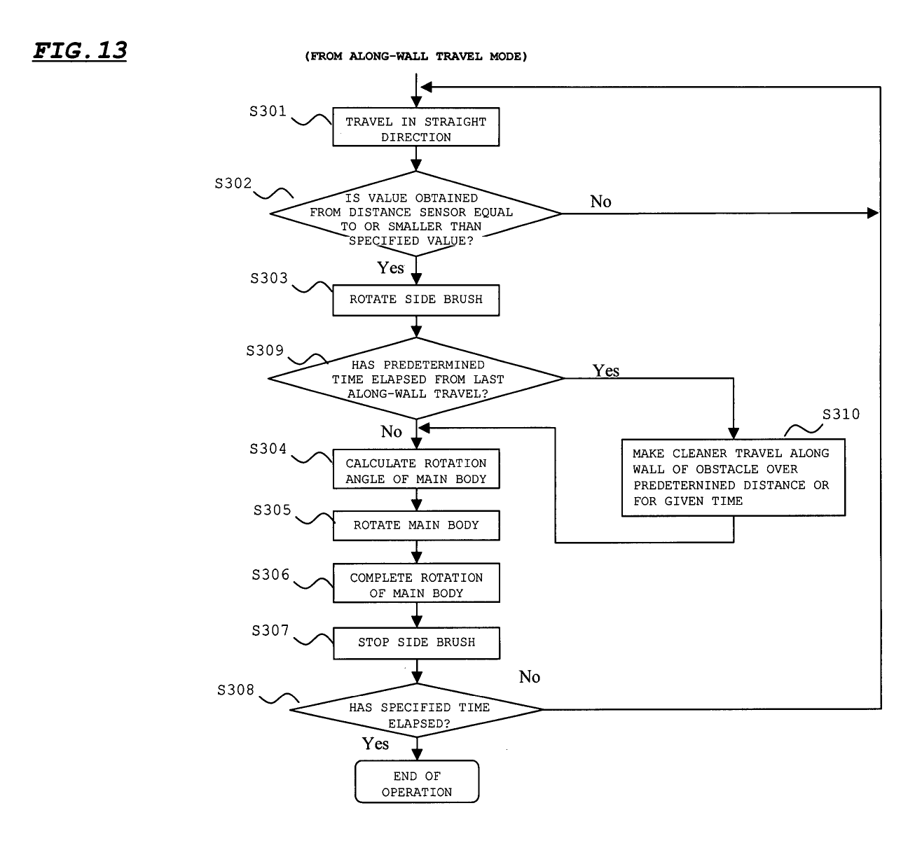

FIG. 13 shows a flow chart of this operation form. In FIG. 13, the operation from Step S301 to Step S308 is the same as that from Step S201 to Step S208 shown in FIG. 10. In the operation form shown in FIG. 13, when the operation proceeds from Step S303 to Step S304, it is judged in Step S309 whether or not the cleaning is carried out while the cleaner 100 travels along a wall, an obstacle, or the like.

In Step S309, it is judged at first time whether or not a predetermined time has elapsed from the start of the along-wall travel mode. Also, it is judged from the next time on whether or not a predetermined time has elapsed from the last along-wall travel operation for the cleaning for the vicinity of the obstacle. Here, when it is judged in Step S309 that the predetermined time has elapsed, the operation proceeds to Step S310. On the other hand, when it is judged in Step S309 that no predetermined time has elapsed, the operation proceeds to Step S304. Note that when the mapping operation is carried out during the random travel mode, the control for carrying out operation for the cleaning for the vicinity of the obstacle may be made as follows. That is, the control for carrying out the along-wall cleaning operation for the cleaning for the vicinity of the obstacle is carried out at first time, and from next time, only after a lapse of the predetermined time, the operation is carried out. This control is made for each obstacle.

In Step S310, the cleaning using the side brush 5 is carried out while the cleaner 100 travels forward along the wall, the obstacle, or the like, for a given time or over a predetermined distance while holding the distance to the obstacle or the like constant. Note that when the cleaner 100 reaches the corner or angle of the obstacle or the like, the direction is changed similarly to the cases of FIGS. 8A to 8D and FIGS. 9A to 9D which were described in the above-mentioned along-wall travel mode, and after that, the same along-wall cleaning is continuously carried out. Then, the operation proceeds to Step S304.

Note that, in the foregoing, in the case shown in FIGS. 9A to 9D, the travel direction of the cleaner 100 is changed after the cleaner 100 has passed the angle of the wall, and the cleaning operation is carried out using the side brush 5 while the cleaner 100 travels along the wall of the obstacle or the like. However, in Step S310 in this embodiment, after completion of the operation for carrying out the cleaning while the cleaner 100 travels along the obstacle or the like, e.g., goes straight on after having passed the corner or angle of the wall, the operation may proceed to Step S307. In addition, a procedure may also be adopted in which after the change of the travel direction is completed in FIG. 9C, the cleaner 100 moves backward once to clean a place just near the angle using the side brush 5, and thus after the place is cleaned which has not been cleaned using the side brush 5 in the operation for turning the cleaner 100 to the left in FIG. 9B, the forward movement of the cleaner 100 is restarted.

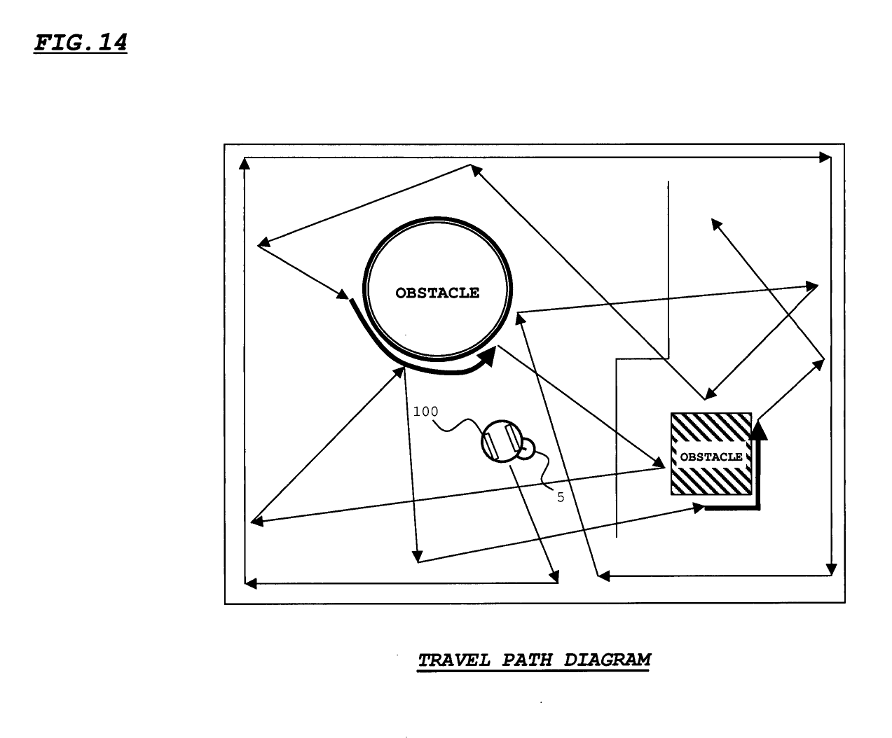

FIG. 14 shows an example of the cleaning operations in the along-wall travel mode and the random travel mode when the cleaning operation is carried out in accordance with the operation flow shown in FIG. 13. In FIG. 14, the bold line indicates a state in which the cleaner 100 carries out the cleaning while traveling along an obstacle after having avoided the collision with the obstacle. Note that FIG. 14 does not especially show a path in the along-wall travel mode and a path in the random travel mode distinguished from each other.

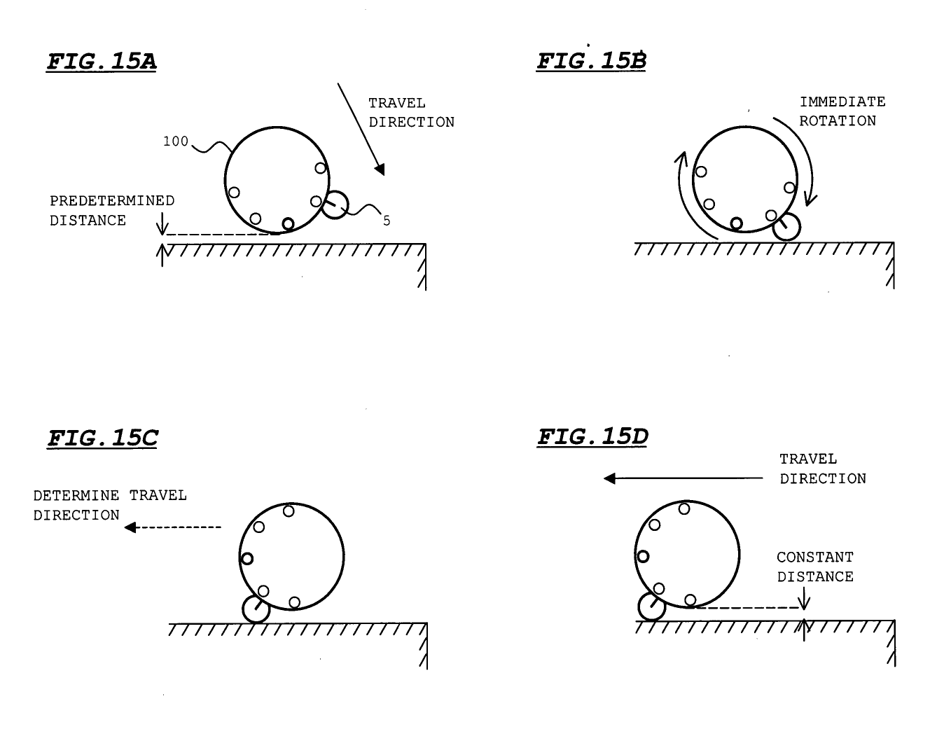

A description will hereinafter be given with respect to the operation when the travel along the obstacle is started in Step S310 with reference to FIGS. 15A to 15D.

When in FIG. 15A, a sensor pair of the cleaner 100 detects an obstacle, the cleaner 100 is stopped at a predetermined distance from the obstacle. Next, in FIG. 15B, the cleaner 100 is rotated immediately using the detection results obtained by the sensor pair to change the travel direction of the cleaner 100. After that, in FIG. 15C, after the rotation of the cleaner 100 is completed, the travel direction of the cleaner 100 is determined accordingly. Then, in FIG. 15D, the cleaner 100 starts to move forward while keeping a constant distance to the wall using the detection results obtained by the sensor pair. After that, the cleaner 100 carries out the cleaning using the side brush 5 over a predetermined distance or for a given time while traveling along the obstacle.

This embodiment has shown the form in which the cleaning operation proceeds from the along-wall travel mode to the random travel mode. However, the cleaning operation may not proceed to the random travel mode, but may proceed to a systematic travel mode in which the cleaner 100 carries out the cleaning while systematically traveling in accordance with a certain rule. In this case, however, for example, it is necessary to precisely carry out the mapping of the obstacle or the like and the check of the cleaner's own position as compared with this embodiment. In order to attain this, it is necessary to carry out the special control. As a result, the installation or the like of an extra hardware resource is required. Thus, there is a possibility that the inexpensiveness, the lightness, and the compactness are impaired. Moreover, the finite energy accumulated in a secondary battery is consumed.

In addition, in the above-mentioned embodiment, the along-wall operation or the like is carried out using one of a plurality of obstacle detecting sensors. However, the stabilization of the along-wall operation or the like may be enhanced using two or more sensors.

Note that the scope of the present invention is not intended to be limited to the above-mentioned embodiment. The embodiment of the present invention may be suitably and variously changed within the range of the technical idea shown in the appended claims.

What is claimed is:

1. A cleaner having dust collecting means and a side brush, comprising:
obstacle detecting means for detecting an obstacle; and
brush control means for controlling drive of the side brush based on detection results obtained by the obstacle detecting means,
wherein when judging based on the detection results that there is an obstacle, the brush control means starts to drive the side brush, and when judging based on the detection results that there is no obstacle, the brush control means stops driving the side brush.

2. A cleaner according to claim 1, wherein when the detection results obtained by the obstacle detecting means reveal that a distance to an obstacle is equal to or smaller than a first predetermined value, the brush control means judges that an obstacle is present and drives the side brush, and when the detection results obtained by the obstacle detecting means reveal that the distance to the obstacle is beyond the first predetermined value, the brush control means judges that no obstacle is present and stops driving the side brush.

3. A cleaner according to claim 1 or 2, further comprising self-propelled movement means.

4. A cleaner according to claim 3, wherein when the detection results obtained by the obstacle detecting means reveal that the distance to the obstacle is equal to or smaller than a second predetermined value, the self-propelled movement means changes a travel direction of the cleaner while the brush control means drives the side brush.

5. A cleaner according to claim 4, wherein after the self-propelled movement means changes the travel direction of the cleaner, the brush control means stops driving the side brush.

6. A cleaner according to claim 5, wherein when the detection results obtained by the obstacle detecting means reveal that the distance to the obstacle becomes equal to or larger than a third predetermined value after the self-propelled movement means changes the travel direction of the cleaner, the brush control means stops driving the side brush.

7. A cleaner according to claim 3, wherein the cleaner carries out self-propelled travel while the brush control means drives the side brush and the self-propelled movement means maintains the distance to the obstacle, based on the detection results obtained by the obstacle detecting means.
